(19) United States
(12) Patent Application Publication
(10) Pub. No.: US 2009/0317665 A1
(43) Pub. Date: Dec. 24, 2009

(54) Secondary battery

(76) Inventors: Sooyeon Maeng, Yongin-si (KR); Jinha Jun, Yongin-si (KR)

Correspondence Address: LEE & MORSE, P.C., 3141 FAIRVIEW PARK DRIVE, SUITE 500, FALLS CHURCH, VA, 22042, US

(21) Appl. No.: 12/457,426

(22) Filed: Jun. 10, 2009

(30) Foreign Application Priority Data
Jun. 23, 2008 (KR) 10-2008-0059129

(51) Int. Cl. H01M 10/50

(52) U.S. Cl. 429/7

(57) ABSTRACT

A secondary battery including an electrode assembly having a positive electrode and a negative electrode, a can accommodating the electrode assembly and electrically connected to one of the positive electrode and negative electrode, a cap assembly sealing a top opening of the can, and a discharge inducing member configured to electrically connect the can and the other of the positive electrode and negative electrode and cause current drain when the secondary battery is compressed.

### BACKGROUND

1. Field

Embodiments relate to a secondary battery, and more particularly, to a secondary battery that quickly discharges current through current drain when longitudinally compressed, to prevent fire or explosion due to battery overheating.

2. Description of the Related Art

The voltage of a secondary battery may rapidly rise due to, e.g., a short circuit internal or external to the electrode assembly, overcharge, or overdischarge. Excessive heat generated due to the rapid voltage rise may cause an accident, e.g., fire or explosion.

Fires or explosions from secondary batteries in recent years have caused consumers to develop a feeling of insecurity and lowered perceptions of battery reliability. Safety tests and standards of countries importing secondary batteries have also been more frequently invoked.

In safety tests on secondary batteries, the lithium-ion cells are tested for fires and explosions under electrical conditions, e.g., cell short-circuiting, abnormal charging, overcharging and forced discharging, and under physical conditions, e.g., vibration and shock.

Particularly, in a longitudinal compression test of a secondary battery, pressure may be abruptly applied from the outside to two opposing sides of the battery can, and the safety of the battery relative to the deformation is examined. When a secondary battery is longitudinally compressed, the electrode assembly may be deformed, and the active material of the positive electrode plate may be brought into direct contact with that of the negative electrode plate and electrochemical reactions may occur, leading to a short. This may increase the possibility of smoke and flame generation and involves a high risk of explosion. If controlled current discharge is induced through a different path before a short occurs due to contact between the active materials of the positive electrode plate and negative electrode plate, the risk of a fire and explosion may be greatly reduced.

Generally, when a secondary battery is longitudinally compressed, the can of the battery is compressed first and deformed. If controlled current drain is achieved by having an electrical short between the can and an element having a polarity different from that of the can, the risk of a fire and explosion of the battery may be greatly reduced.

### SUMMARY

Embodiments are therefore directed to a secondary battery, which substantially overcomes one or more of the problems due to the limitations and disadvantages of the prior art.

It is therefore a feature of an embodiment to provide a secondary battery that quickly discharges current through controlled current drain when longitudinally compressed.

At least one of the above and other features and advantages may be realized by providing a secondary battery including an electrode assembly having a positive electrode and a negative electrode, a can accommodating the electrode assembly and electrically connected to one of the positive electrode and negative electrode, a cap assembly sealing a top opening of the can, and a discharge inducing member configured to electrically connect the can and the other of the positive electrode and negative electrode and cause current drain when the secondary battery is compressed.

The can may include wide sides and first and second narrow sides narrower than the wide sides, and the discharge inducing member may include a terminal plate extending in a direction towards one of the narrow sides of the can and is configured to contact a side of the can when the secondary battery is longitudinally compressed.

The cap assembly may include an insulating plate, the terminal plate and the insulating plate may each have a first end, the first ends of the terminal plate and the insulating plate may each face the first narrow side of the can, the first end of the terminal plate may be longer than the first end of the insulating plate and the first end of the terminal plate may be configured to contact the first narrow side of the can when the secondary battery is longitudinally compressed.

The battery may include a gap d between the first end of the terminal plate and the first narrow side of the can, and the gap may be about 0.5 mm to about 3.5 mm.

The gap d between the first end of the terminal plate and the first narrow side of the can may be about 1 mm.

The insulating plate may include a base plate having edges, a side wall extending from at least one of the edges of the base plate, and an unwalled portion at the first end of the insulating plate facing the first narrow side.

The cap assembly may include an insulating plate, the terminal plate and the insulating plate may each have a second end, the second ends of the terminal plate and the insulating plate may face the second narrow side of the can, the second end of the terminal plate may be longer than the second end of the insulating plate and the second end of the terminal plate may be configured to contact a wide side of the can when the secondary battery is longitudinally compressed.

The insulating plate may include a base plate having edges, a side wall extending from at least one of the edges of the base plate, and an unwalled portion at an edge of the insulating plate facing the second narrow side.

The positive electrode may include a positive electrode tab, and the can may be electrically connected to the positive electrode tab of the electrode assembly.

The negative electrode may include a negative electrode tab, and the terminal plate may be electrically connected to the negative electrode tab of the electrode assembly.

The secondary battery may further include an insulating case between the electrode assembly and cap assembly, wherein the discharge inducing member includes a conductive plate in the insulating case.

The conductive plate may be stacked on an upper surface of the insulating case.

The conductive plate and insulating case may be formed as a single entity through insert injection molding.

The conductive plate may include an electrode tab through-hole through which an electrode tab of the electrode assembly passes.

The electrode tab passing through the electrode tab through-hole of the conductive plate may be a negative electrode tab.

The can may be electrically connected to the positive electrode of the electrode assembly.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates an exploded perspective view of a secondary battery according to an embodiment;

FIG. 2 illustrates a partial longitudinal sectional view of the battery shown in FIG. 1;

FIG. 3 illustrates a sectional view along the line A-A′ of FIG. 2;

FIG. 4 illustrates a sectional view of a secondary battery according to another embodiment;

FIG. 5 illustrates a sectional view of the secondary battery of FIG. 1 in a longitudinally compressed state;

FIG. 6 illustrates a sectional view of the secondary battery of FIG. 4 in a longitudinally compressed state;

FIG. 7 illustrates an exploded perspective view of a secondary battery according to yet another embodiment;

FIG. 8 illustrates a partial longitudinal sectional view of the battery shown in FIG. 7;

FIG. 9 illustrates a sectional view along the line B-B′ of FIG. 8; and

FIG. 10 illustrates a sectional view of the secondary battery shown in FIG. 7 in a longitudinally compressed state.

### DETAILED DESCRIPTION

Korean Patent Application No. 10-2008-0059129, filed on Jun. 23, 2008, in the Korean Intellectual Property Office, and entitled: “Secondary Battery,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

As used herein, the expressions “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C” and “A, B, and/or C” includes the following meanings: A alone; B alone; C alone; both A and B together; both A and C together; both B and C together; and all three of A, B, and C together. Further, these expressions are open-ended, unless expressly designated to the contrary by their combination with the term “consisting of.” For example, the expression “at least one of A, B, and C” may also include an nth member, where n is greater than 3, whereas the expression “at least one selected from the group consisting of A, B, and C” does not.

As used herein, the expression “or” is not an “exclusive or” unless it is used in conjunction with the term “either.” For example, the expression “A, B, or C” includes A alone; B alone; C alone; both A and B together; both A and C together; both B and C together; and all three of A, B, and C together, whereas the expression “either A, B, or C” means one of A alone, B alone, and C alone, and does not mean any of both A and B together; both A and C together; both B and C together; and all three of A, B, and C together.

As used herein, the terms “a” and “an” are open terms that may be used in conjunction with singular items or with plural items. For example, the term “a metal” may represent a single compound, e.g., aluminum, or multiple compounds in combination, e.g., aluminum mixed with nickel.

Hereinafter, embodiments are described in detail with reference to the accompanying drawings. The same reference symbols are used throughout the drawings to refer to the same or like parts. Detailed descriptions of well-known functions and structures incorporated herein may be omitted to avoid obscuring the subject matter.

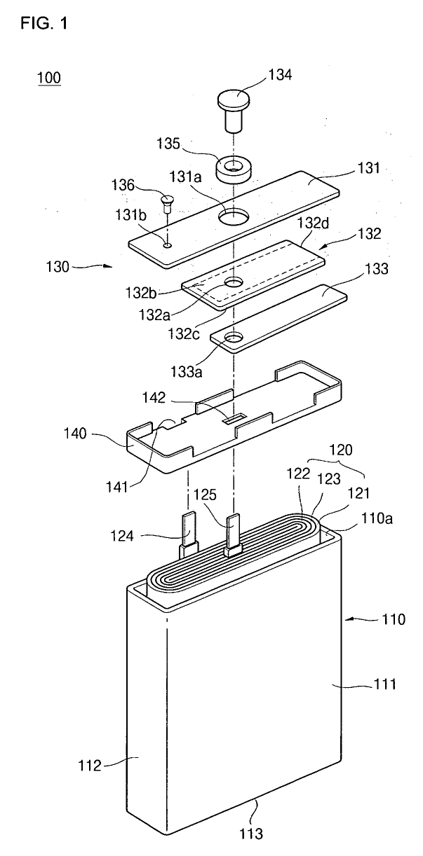

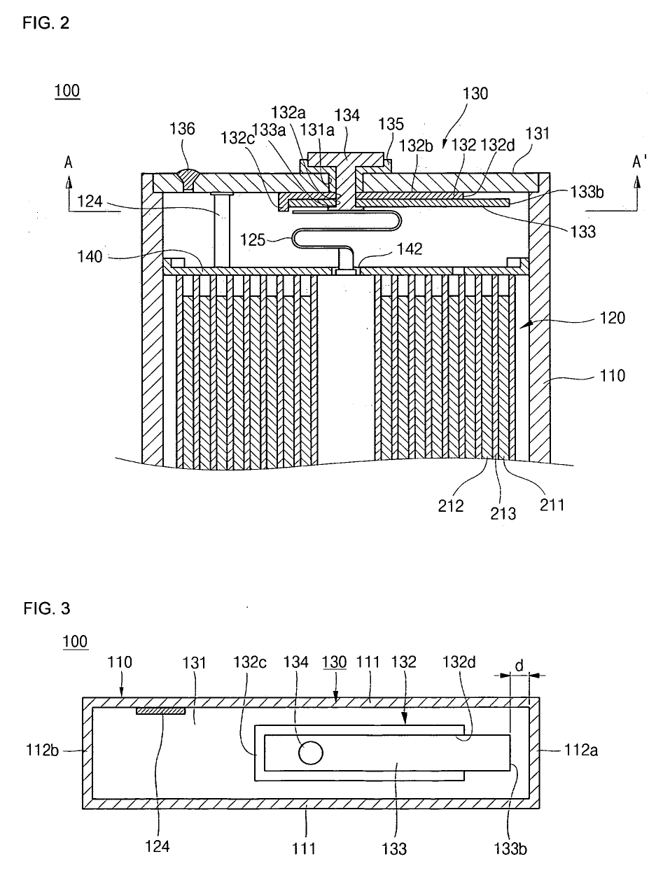

FIG. 1 illustrates an exploded perspective view of a secondary battery 100 according to an embodiment. FIG. 2 illustrates a partial longitudinal sectional view of the secondary battery 100. FIG. 3 illustrates a sectional view along the line A-A′ of FIG. 2.

Referring to FIGS. 1 to 3, the secondary battery 100 may include a can 110, an electrode assembly 120 in the can 110 and a cap assembly 130 sealing the top opening of the can 110. The can 110 may have a shape of a rectangular parallelepiped with the top side open. The can 110 may include a pair of wide sides 111 spaced at a preset distance and having a relatively large area, a pair of narrow sides 112 having an area smaller than that of the wide side 111 and a bottom side 113 at the lower end of the wide sides 111 and narrow sides 112 at right angles. The can 110 may be manufactured through, e.g., a deep drawing process, and the wide sides 111, narrow sides 112 and bottom side 113 may be formed as a single body.

Longitudinal compression may result in deformation of the can 110 caused by compression of the narrow sides 112 due to, e.g., an external force. When longitudinal compression occurs, the narrow sides 112 may be deformed first, the wide sides 111 and bottom side 113 may be deformed next and the electrode assembly 120 in the can 110 may be deformed last. Hence, the secondary battery 100 of an embodiment may be configured so that, when longitudinally compressed, a narrow side 112 of the can 110 that deforms first may contact a terminal plate 133 of the cap assembly 130 to induce controlled discharge. The can 110 may include, e.g., steel, aluminum, and/or an equivalent thereof, however, the embodiments are not limited thereto.

The electrode assembly 120 may include a positive electrode plate 121, a negative electrode plate 122 and a separator 123 interposed therebetween. In the electrode assembly 120, the positive electrode plate 121, negative electrode plate 122 and separator 123 may be wound in a jelly-roll configuration.

Specifically, the electrode assembly 120 may include a positive electrode plate 121 coated with positive electrode active materials, a negative electrode plate 122 coated with negative electrode active materials and a separator 123 between the positive electrode plate 121 and negative electrode plate 122 to prevent a short and permit transport of only ions, e.g., lithium. The positive electrode plate 121 may be made of, e.g., an aluminum foil, the negative electrode plate 122 may be made of, e.g., a copper foil, and the separator 123 may be made of, e.g., polyethylene (PE) or polypropylene (PP), however the embodiments are not limited thereto. A positive electrode tab 124, projecting upwards at a preset length, may be connected to the positive electrode plate 121. A negative electrode tab 125, projecting upwards at a preset length, may be connected to the negative electrode plate 122. The positive electrode tab 124 may be made of, e.g., aluminum, and the negative electrode tab 125 may be made of, e.g., nickel, however the embodiments are not limited thereto.

In the can 110, an electrolyte may be provided together with the electrode assembly 120. The electrolyte may act as a medium for transporting, e.g., lithium ions, which may be generated at the positive electrode plate 121 and negative electrode plate 122 through chemical reactions during charging and discharging in the secondary battery 100. The electrolyte may include, e.g., a non-aqueous organic electrolyte, a mixture of a lithium salt and high-purity organic solvent and may also include a polymer using polyelectrolytes.

The cap assembly 130 may be coupled to the upper portion of the can 110 to prevent outward separation of the electrode assembly 120 and to prevent leakage of the electrolyte. The cap assembly 130 may include a cap plate 131, an insulating plate 132 and a terminal plate 133, which may be coupled together in sequence.

The cap plate 131 may be made of a metal plate, e.g., aluminum or aluminum alloy, and may correspond in size and shape to a top opening 110a of the can 110. A terminal through-hole 131a may be formed at the center of the cap plate 131, and an electrolyte injection hole 131b for electrolyte injection may be formed at an end portion of the cap plate 131. A negative terminal 134 may be inserted into the terminal through-hole 131a, and a tube-shaped gasket 135 may be placed between the through-hole 131a and the head of the negative terminal 134 for insulation when the negative terminal 134 is inserted. The electrolyte may be injected through the electrolyte injection hole 131b after the cap assembly 130 is assembled at the top opening 110a of the can 110. The electrolyte injection hole 131b may be hermetically sealed by a sealing plug 136 after electrolyte injection.

The insulating plate 132, like the gasket 135, may include an insulating material, and may be installed under the cap plate 131. The insulating plate 132 may include a base plate 132b having a terminal through-hole 132a corresponding to the terminal through-hole 131a of the cap plate 131, and a side wall 132c extending from the edge of the base plate 132b. The base plate 132b of the insulating plate 132 may be brought into close contact with the lower surface of the cap plate 131, and the side wall 132c may face downward.

The insulating plate 132 may include an unwalled portion 132d, not including the side wall 132c, at an edge of the base plate 132b. The base plate 132b may have a size corresponding to the area of the terminal plate 133, and the side wall 132c may have a height corresponding to the thickness of the terminal plate 133. The unwalled portion 132d at the edge of the base plate 132b may face one of the narrow sides 112 of the can 110 (first narrow side 112a). Hence, the first end 133b of the terminal plate 133 may protrude outwardly through the unwalled portion 132d of the insulating plate 132.

The terminal plate 133 may include a metal, e.g., nickel or nickel alloy, and may be installed at the lower surface of the base plate 132b of the insulating plate 132. The terminal plate 133 may include a terminal through-hole 133a corresponding to the terminal through-hole 132a of the insulating plate 132.

The terminal plate 133 protruding through the unwalled portion 132d of the insulating plate 132 may have a sufficient length so that the terminal plate 133 may contact the narrow side 112 of the can 110 when the battery is longitudinally compressed. The gap d between the first end 133b of the terminal plate 133 and the narrow side 112 of the can 110 may be about 0.5 mm to about 3.5 mm.

Maintaining the gap d at about 0.5 mm or greater may help ensure that the first end 133b of the terminal plate 133 is not too close to the narrow side 112 of the can 110. This may help prevent the first end 133b of the terminal plate 133 from contacting the can and causing unwanted discharge without can deformation due to longitudinal compression. Maintaining the gap d at about 3.5 mm or less may help ensure that the electrode assembly 120 does not become significantly deformed before the terminal plate 133 contacts the can 110, which may prevent an internal short from occurring in the electrode assembly 120 and in turn preventing a battery fire or explosion. Hence, to achieve the desired purpose, the gap d may be set to about 0.5 mm to about 3.5 mm in consideration of the assembly tolerance.

Preferably, the gap d between the first end 133b of the terminal plate 133 and the narrow side 112 of the can 110 is about 1 mm. A gap d of about 1 mm may prevent unwanted current drain due to a mild external shock without battery deformation before longitudinal compression but may still cause controlled current drain prior to an electrical short in the electrode assembly 120 when the battery is longitudinally compressed.

The negative terminal 134 may be inserted through the terminal through-holes 131a, 132a and 133a of the cap plate 131, insulating plate 132 and terminal plate 133. When the negative terminal 134 is inserted through the terminal through-holes 131a, 132a and 133a, the negative terminal 134 may be insulated by the gasket 135 from the cap plate 131 and may be electrically connected to the terminal plate 133. Thus, the terminal plate 133 connected to the negative terminal 134 may have a negative polarity.

The negative terminal 134 may be connected to the negative electrode tab 125, the positive electrode tab 124 may be connected to the cap plate 131; and thus the can 110 connected to the cap plate 131 may have a positive polarity. Thus, when the terminal plate 133 having a negative polarity is brought into contact with the can 110 having a positive polarity, controlled discharge may occur. If the positive electrode tab 124 is connected to the negative terminal 134 and the negative electrode tab 125 is connected to the cap plate 131, polarities of the can 110 and terminal plate 133 may change accordingly.

Inside the can 110, an insulating case 140 may be further provided between the electrode assembly 120 and cap assembly 130. The insulating case 140 may include a positive electrode tab setback 141, through which the positive electrode tab 124 may be connected to the cap plate 131, and a negative electrode tab through-hole 142, through which the negative electrode tab 125 may be connected to the terminal plate 133.

Next, a secondary battery according to another embodiment is described. Like the secondary battery 100 described above, a secondary battery 200 according to another embodiment may include a can 110, an electrode assembly 120 in the can 110, and a cap assembly 230 sealing the top opening of the can 110. Some elements of the can 110, electrode assembly 120 and cap assembly 230 have the same configurations as those of the secondary battery 100, and repeated descriptions are omitted.

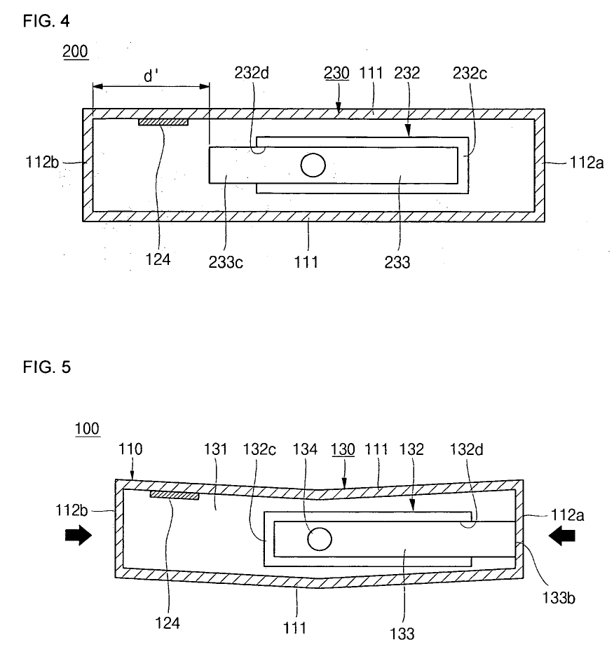

Referring to FIG. 4, in the secondary battery 200, an insulating plate 232 and terminal plate 233 of the cap assembly 230 may be different from corresponding ones in the secondary battery 100 described above. In the secondary battery 200, the insulating plate 232 may include a side wall 232c and an unwalled portion 232d in a direction facing the second narrow side 112b of the can 110.

The terminal plate 233 may be longer than the insulating plate 232. That is, a second end 233c of the terminal plate 233 may project outwards beyond the insulating plate 232. The second end 233c of the terminal plate 233 may protrude through the unwalled portion 232d.

The positive electrode tab 124 may be installed between the second end 233c of the terminal plate 233 and second narrow side 112b of the can 110. When longitudinally compressed, the second end 233c of the terminal plate 233 may contact a wide side 111 of the can 110 rather than the second narrow side 112b of the can 110, causing controlled current discharge. Hence, it may be unnecessary to limit the gap d′ between the second end 233c of the terminal plate 233 and second narrow side 112b of the can 110.

Next, the functions of the secondary batteries having the above configurations are described. Referring to FIGS. 3 and 5, in the secondary battery 100, the positive electrode tab 124 and negative electrode tab 125 may be connected to the cap assembly 130, and then the cap assembly 130 may be coupled to the top opening 110a of the can 110. In this state, the first end 133b of the terminal plate 133 may be separated by the gap d from the first narrow side 112a of the can 110.

When the secondary battery 100 is longitudinally compressed due to, e.g., external forces applied to the narrow sides 112a and 112b of the can 110, the first narrow side 112a of the can 110 may contact the first end 133b of the terminal plate 133. Hence, at the early stages of longitudinal compression, the can 110 having a positive polarity may contact the terminal plate 133 having a negative polarity, resulting in rapid controlled current discharge. This current discharge may occur before the electrode assembly 120 is deformed, thereby preventing a battery fire or explosion due to overheating of the electrode assembly 120.

As described above, in the secondary battery 100 being longitudinally compressed, the first narrow side 112a of the can 110 may contact the first end 133b of the terminal plate 133, causing controlled current drain at the early stages of longitudinal compression.

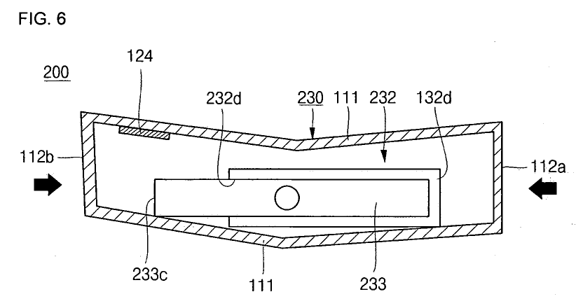

Further, referring to FIGS. 4 and 6, in the secondary battery 200, the positive electrode tab 124 and negative electrode tab 125 may be connected to the cap assembly 230, and then the cap assembly 230 may be coupled to the top opening 110a of the can 110. In this state, the second end 233c of the terminal plate 233 protruding beyond the unwalled portion 232d of the insulating plate 232 may be separated from the second narrow side 112b and wide sides 111 of the can 110.

When the secondary battery 200 is longitudinally compressed due to, e.g., external forces applied to the narrow sides 112a and 112b of the can 110, the wide sides 111 of the can 110 may be bent and one of the wide sides 111 may contact the second end 233c of the terminal plate 233. Hence, the can 110 having a positive polarity may contact the terminal plate 233 having a negative polarity, resulting in rapid controlled current discharge. This current discharge may occur before the electrode assembly 120 is overheated due to, e.g., an internal short, thereby preventing an accident, e.g., a battery fire or explosion. As described above, in the secondary battery 200 being longitudinally compressed, one of the wide sides 111 of the can 110 may contact the second end 233c of the terminal plate 233, causing controlled discharge.

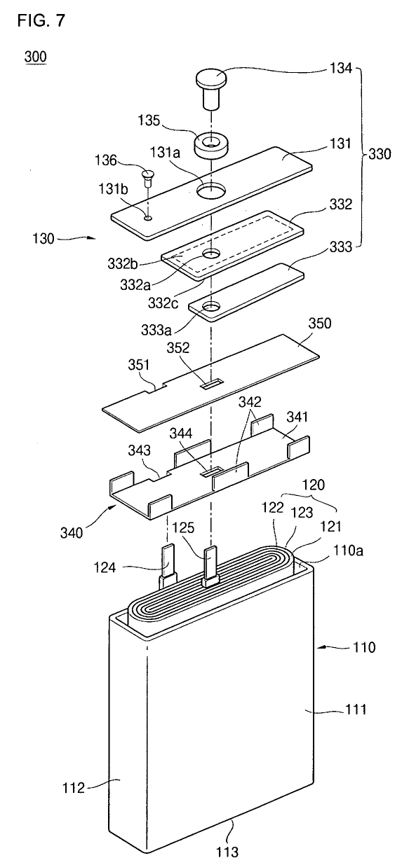

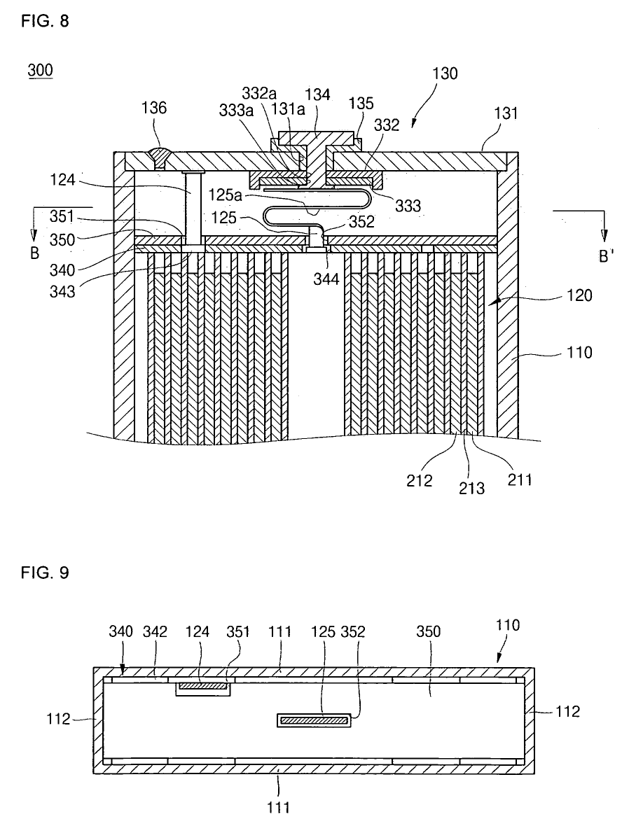

Next, a secondary battery according to yet another embodiment is described. FIG. 7 illustrates an exploded perspective view of a secondary battery 300 according to the embodiment. FIG. 8 illustrates a partial longitudinal sectional view of the battery of FIG. 7. FIG. 9 illustrates a sectional view along the line B-B′ of FIG. 8.

Referring to FIGS. 7 to 9, the secondary battery 300 may include a can 110, an electrode assembly 120 in the can 110, a cap assembly 330 sealing the top opening of the can 110, an insulating case 340 to insulate the electrode assembly 120 and cap assembly 330 and a conductive plate 350 on the upper surface of the insulating case 340.

The can 110 and electrode assembly 120 in the secondary battery 300 may have the same configurations as those of the can 110 and electrode assembly 120 in the secondary battery 100 described above, and repeated descriptions thereof are omitted. The same reference numerals are used for the same elements.

The cap assembly 330 may include a cap plate 131, insulating plate 332 and terminal plate 333. The cap plate 131 in the secondary battery 300 may be the same as that in the secondary battery 100 described above, and repeated description thereof is omitted.

The insulating plate 332 may include a base plate 332b having a terminal through-hole 332a, and side walls 332c protruding downwardly from the edge of the base plate 332b. In the insulating plate 332, the side wall 332c may be continuously formed along four sides of the base plate 332b and may enclose four sides of the terminal plate 333 installed at the lower surface of the insulating plate 332.

The terminal plate 333 may include a terminal through-hole 333a corresponding to the terminal through-hole 332a of the insulating plate 332, and may not be longer than the insulating plate 332. Ends of the terminal plate 333 may not project outwards from the insulating plate 332.

The insulating case 340 may include a base plate 341, and ribs 342 projecting upwards along two long sides of the base plate 341. The base plate 341 may include a positive electrode tab setback 343 and negative electrode tab through-hole 344. The positive electrode tab 124 of the electrode assembly 120 may be electrically connected to the cap plate 131 through the positive electrode tab setback 343. The negative electrode tab 125 of the electrode assembly 120 may be electrically connected to the terminal plate 333 through the negative electrode tab through-hole 344.

The conductive plate 350 may include a positive electrode tab setback 351, through which the positive electrode tab 124 may pass, and a negative electrode tab through-hole 352, through which the negative electrode tab 125 may pass. The positive electrode tab setback 351 may have a cross section larger than that of the positive electrode tab 124, and the negative electrode tab through-hole 352 may have a cross section larger than that of the negative electrode tab 125. The positive electrode tab 124 and negative electrode tab 125 may not contact the conductive plate 350.

The conductive plate 350 may be longer than the base plate 341 of the insulating case 340. The ends of the conductive plate 350 may contact the narrow sides 112 of the can 110, and the conductive plate 350 may have a positive polarity (the same as the polarity of the can 110).

In the secondary battery 300 of FIGS. 7 and 8, the conductive plate 350 and the insulating case 340 are described as separate entities. The insulating case 340 may manufactured from, e.g., synthetic resin; and the conductive plate 350 may be formed through insert injection molding during molding of the insulating case 340. Hence, the insulating case 340 and conductive plate 350 may also be formed as a single entity.

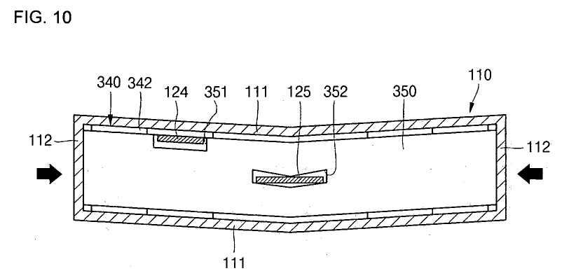

Next, the functions of the secondary battery 300 having the above configurations are described. Referring to FIGS. 9 and 10, in the secondary battery 300, before longitudinal compression, the negative electrode tab 125 of the electrode assembly 120 may be connected through the negative electrode tab through-hole 352 of the conductive plate 350 to the terminal plate 333 of the cap assembly 330. The negative electrode tab 125 may not be electrically connected to the conductive plate 350.

The ends of the conductive plate 350 may contact the narrow sides 112 of the can 110, and the conductive plate 350 may have a positive polarity. Even though the positive electrode tab 124 of the electrode assembly 120 may contact the conductive plate 350 while passing through the positive electrode tab setback 351 of the conductive plate 350, a short may not occur because the positive electrode tab 124 and conductive plate 350 may have the same polarity.

When the secondary battery 300 is longitudinally compressed due to, e.g., external forces applied to the narrow sides 112 of the can 110, the insulating case 340 and the conductive plate 350 at the upper surface of the insulating case 340 may become bent due to deformation of the wide sides 111 of the can 110. The negative electrode tab through-hole 352 may be distorted, and the negative electrode tab 125 may contact the conductive plate 350 causing controlled current discharge.

In addition, if the secondary battery 300 is longitudinally compressed further, the conductive plate 350 may bend upwards; and the upper surface of the conductive plate 350 may contact a bent surface 125a of the negative electrode tab 125 bent in a zigzag shape, advantageously causing further controlled current discharge.

As described above, in the secondary battery 300 being longitudinally compressed, the conductive plate 350 electrically connected to the can 110 having a positive polarity may contact the negative electrode tab 125, resulting in rapid controlled current discharge. This current discharge may occur at the early stages of longitudinal compression, thereby preventing an accident, e.g., a battery fire or explosion, due to, e.g., overheating of the electrode assembly 120. In the secondary battery 300, when longitudinally compressed, the conductive plate 350 at the upper surface of the insulating case 340 may contact the can 110; and the negative electrode tab 125 passing through the insulating case 340 may contact the conductive plate 350, causing controlled current drain.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope as set forth in the following claims.

What is claimed is:

1. A secondary battery, comprising:
an electrode assembly having a positive electrode and a negative electrode;
a can accommodating the electrode assembly and electrically connected to one of the positive electrode and negative electrode;
a cap assembly sealing a top opening of the can; and
a discharge inducing member configured to electrically connect the can and the other of the positive electrode and negative electrode and cause current drain when the secondary battery is compressed.

2. The secondary battery as claimed in claim 1, wherein:
the can includes wide sides and first and second narrow sides narrower than the wide sides, and
the discharge inducing member includes a terminal plate extending in a direction towards one of the narrow sides of the can and is configured to contact a side of the can when the secondary battery is longitudinally compressed.

3. The secondary battery as claimed in claim 2, wherein the cap assembly includes an insulating plate, the terminal plate and the insulating plate each have a first end, the first ends of the terminal plate and the insulating plate each face the first narrow side of the can, the first end of the terminal plate is longer than the first end of the insulating plate and the first end of the terminal plate is configured to contact the first narrow side of the can when the secondary battery is longitudinally compressed.

4. The secondary battery as claimed in claim 3, wherein the battery includes a gap d between the first end of the terminal plate and the first narrow side of the can, and the gap is about 0.5 mm to about 3.5 mm.

5. The secondary battery as claimed in claim 4, wherein the gap d between the first end of the terminal plate and the first narrow side of the can is about 1 mm.

6. The secondary battery as claimed in claim 3, wherein the insulating plate includes a base plate having edges, a side wall extending from at least one of the edges of the base plate, and an unwalled portion at the first end of the insulating plate facing the first narrow side.

7. The secondary battery as claimed in claim 2, wherein the cap assembly includes an insulating plate, the terminal plate and the insulating plate each have a second end, the second ends of the terminal plate and the insulating plate face the second narrow side of the can, the second end of the terminal plate is longer than the second end of the insulating plate and the second end of the terminal plate is configured to contact a wide side of the can when the secondary battery is longitudinally compressed.

8. The secondary battery as claimed in claim 7, wherein the insulating plate includes a base plate having edges, a side wall extending from at least one of the edges of the base plate, and an unwalled portion at an edge of the insulating plate facing the second narrow side.

9. The secondary battery as claimed in claim 2, wherein the positive electrode includes a positive electrode tab, and the can is electrically connected to the positive electrode tab of the electrode assembly.

10. The secondary battery as claimed in claim 2, wherein the negative electrode includes a negative electrode tab, and the terminal plate is electrically connected to the negative electrode tab of the electrode assembly.

11. The secondary battery as claimed in claim 1, further comprising an insulating case between the electrode assembly and cap assembly, wherein the discharge inducing member includes a conductive plate in the insulating case.

12. The secondary battery as claimed in claim 11, wherein the conductive plate is stacked on an upper surface of the insulating case.

13. The secondary battery as claimed in claim 11, wherein the conductive plate and insulating case are formed as a single entity through insert injection molding.

14. The secondary battery as claimed in claim 11, wherein the conductive plate includes an electrode tab through-hole through which an electrode tab of the electrode assembly passes.

15. The secondary battery as claimed in claim 14, wherein the electrode tab passing through the electrode tab through-hole of the conductive plate is a negative electrode tab.

16. The secondary battery as claimed in claim 11, wherein the can is electrically connected to the positive electrode of the electrode assembly.
